(19) United States
(12) Patent Application Publication
(10) Pub. No.: US 2005/0167358 A1
(43) Pub. Date: Aug. 4, 2005

(54) Carbon Block Filters

(76) Inventors: Eric Taylor, Oakland, CA (US); Edward Rinker, Oakland, CA (US)

Correspondence Address: THE CLOROX COMPANY, 1221 BROADWAY, PO BOX 2351, OAKLAND, CA, 94623, US

(21) Appl. No.: 10/756,478

(22) Filed: Jan. 12, 2004

(51) Int. Cl. B01D 39/14

(52) U.S. Cl. 210/502.1; 210/510.1; 502/416

(57) ABSTRACT

Abstract of the Disclosure

A system for treating a fluid is described. The system includes a fluid source and a porous composite block with at least one binding agent in particle form, an inlet and an outlet. All binding agents together constitute less than approximately 15 weight percent of the porous composite block. A porous composite block is also described. The block includes a first component in grain form and at least one binding agent in particle form, wherein, on average, than about 20 μm, and all binding agents together constitute less than approximately 15 weight percent of the porous composite block. In other arrangements, on average, at least one dimension of the particles is less than about 10 μm. In still other arrangements all binding agents together constitute less than approximately 10 weight percent of the porous composite block. The first granular component can be activated carbon. The block can also contain a second granular component such as activated alumina, activated bauxite, fuller’s earth, diatomaceous earth, silica gel, calcium sulfate, ceramic particles, zeolite particles, inert particles, sand, surface charge-modified particles, metal oxides, metal hydroxides, and mixtures thereof.

### Detailed Description of the Invention

### Field of the Invention

The present invention is directed generally to binders for composite particle blocks and, more specifically, to binders for composite carbon block water filters.

### Description of the Related Art

Typically, a composite block filter is a hollow core cylindrical block of bonded, activated charcoal granules. Water flows through the perimeter of the charcoal filter, into the center core and on to the user. It is the interaction of water with the carbon surface and pores on the carbon surface that provides filtration. It is desirable to use fine charcoal granules as they provide more surface area per unit volume than do coarse granules. But if the charcoal particles are fine enough to provide optimum filtering, they can inhibit water flow by packing too closely.

Another problem with composite block filters is that the binder used to bond the charcoal granules can cover the surface and clog the pores of the activated charcoal. Clogging reduces filtration efficiency by reducing the exposed surface area of the activated charcoal.

Accordingly, there is a need for improved processes and materials for making carbon and other porous composite blocks.

### Summary of the Invention

In accordance with one aspect of the present invention, a system for treating a fluid is provided. The system includes a fluid source, a porous composite block with at least one binding agent in particle form, an inlet and an outlet. All binding agents together constitute less than approximately 15 weight percent of the porous composite block.

In another embodiment of the invention, a porous composite block is provided. The block includes a first component in grain form and at least one binding agent in particle form, wherein, on average, at least one dimension of the particles is less than about 20 μm, and all binding agents together constitute less than approximately 15 weight percent of the porous composite block. In other arrangements, on average, at least one dimension of the particles is less than about 10 μm. In still other arrangements all binding agents together constitute less than approximately 10 weight percent of the porous composite block.

In some embodiments, the first granular component is activated carbon. In other embodiments, the block can also contain a second granular component such as activated alumina, activated bauxite, fuller’s earth, diatomaceous earth, silica gel, calcium sulfate, ceramic particles, zeolite particles, inert particles, sand, surface charge-modified particles, metal oxides, metal hydroxides, and mixtures thereof.

Methods of making porous composite blocks are also provided.

Further features and advantages of the present invention will become apparent to those of ordinary skill in the art in view of the detailed description of the embodiments below, when considered together with the attached drawings and claims.

### Brief Description of the Drawings

The foregoing aspects and others will be readily appreciated by the skilled artisan from the following description of illustrative embodiments when read in conjunction with the accompanying drawings.

Figure 1A is an idealized view of granules and a large binding agent particle before heating.

Figure 1B is an idealized view of the mixture of Figure 1A after treatment with heat and pressure to bind the granules together.

Figure 2A is an idealized view of granules and a very small binding agent particle before heating.

Figure 2B is an idealized view of the mixture of Figure 2A after treatment with heat and pressure to bind the granules together in a embodiment wherein the binding agent particle has not flowed.

Figure 3A is an idealized view of granules and a very small binding agent particle before heating.

Figure 3B is an idealized view of the mixture of Figure 3A after treatment with heat and pressure to bind the granules together in a embodiment wherein the binding agent particle has flowed.

Figure 4A is an idealized view of a mixture of granules with a small amount of very small binding agent particles before heating.

Figure 4B is an idealized view of the mixture of Figure 4A after treatment with heat and pressure to bind the granules together.

Figure 5A shows the volume percent occupied by binder for a porous composite block that contains 20 weight percent binder.

Figure 5B shows the volume percent occupied by binder for a porous composite block that contains 10 weight percent binder and the additional amount of granule volume that can be contained in a block of the same size as in Figure 5A.

### Detailed Description

The embodiments of the invention are illustrated in the context of porous composite carbon blocks for use in water filtration systems. The skilled artisan will readily appreciate, however, that the materials and methods disclosed herein will have application in a number of other contexts where porous composite blocks that have large amounts of surface area available for interaction with a fluid are desirable, such as, for example, in air purification, or catalytic treatment.

The term “porous composite block” is used herein to mean a block which is porous and permeable to a fluid. The term “granule” is to be construed broadly as encompassing any particulate which may be suitable for use in porous composite blocks. As used herein, the term “fluid” is meant to include both gases and liquids.

Conventionally, the basic components of porous composite carbon block filters include activated carbon granules and a polymer binder. Other active components can also be included in the blocks as desired for specific fluid treatment applications. Typically the polymer binder constitutes between about 20 and 40 wt% (weight percent) of the total block. Presently, activated carbon granules are relatively inexpensive. Polymer binder materials are relatively expensive and can account for a large portion of the cost of a block.

In addition to activated carbon, granular components of a porous composite block may include, for example, activated alumina, activated bauxite, fuller’s earth, diatomaceous earth, silica gel, calcium sulfate, magnesia, ceramic particles, zeolite particles, inert particles, silica, mixed oxides, surface charge-modified particles, metal oxides, metal hydroxides or mixtures thereof.

Additional examples of filter materials that may be combined with activated carbon are disclosed in U.S. Patent Nos. 6,274,041 and 5,679,248 which are incorporated by reference herein.

The process of binding carbon granules together to form porous composite carbon blocks involves some loss of exposed carbon surface, as the portions of the surfaces that are bound together are no longer exposed. Nevertheless it is useful to bind granules together in ways that minimize surface loss.

Conventionally, UHMW polymers with very low melt indices have been popular binding agents because they stick to the carbon granules without flowing and without significantly wetting the granules. Binder particle sizes are usually on the same order as carbon grain sizes. Binders with high melt indices have been avoided because when a binder particle is melted in proximity to a carbon granule, it wets the carbon granule, plugging pores in the granule and covering at least a portion of the carbon granule surface.

Figure 1A is a simplified schematic cross section that shows granules and a large, very low melt index, UHMW (ultra-high molecular weight) binder particle before undergoing treatment to coalesce. In arrangement 100 there are two granules 110, 120 in contact with a binder particle 130. The granules 110, 120 and the binder particle 130 have similar sizes. The granules 110, 120 and the binder particle 130 are shown as spheres for ease of illustration. In general, carbon granules have very irregular shapes.

Figure 1B shows the arrangement 100 of Figure 1A after treatment to coalesce, such as with heat and pressure. Arrangement 100′ shows the granules 110, 120 pressed slightly into and stuck to a post-treatment binder particle 130′. Only granule surface regions 150, 160, pressed into the particle 130′, are covered by the binder 130′ and are therefore unavailable to remove impurities from fluids that pass through the porous composite carbon block during subsequent use. In an actual porous composite block there are many other granules and binder particles in proximity to the arrangement 100′ shown.

Figure 2A is a simplified schematic cross section that shows granules 210, 220 and a very small, very low melt index, UHMWPE (ultra-high molecular weight polyethylene) binder particle 230 before undergoing treatment to coalesce. In arrangement 200 there are two granules 210, 220 in contact with the binder particle 230. The granules 210, 220 and binder particle 230 are shown as spheres for ease of illustration. In general, carbon granules have very irregular shapes.

Figure 2B shows the arrangement 200 of Figure 2A after treatment to coalesce, such as with heat and pressure. Arrangement 200′ shows the granules 210, 220 pressed slightly into and stuck to a post-treatment binder particle 230′. Only granule surface regions 250, 260, pressed into the particle 230′, are covered by the binder 230′ and are therefore unavailable to remove impurities from fluids that pass through the porous composite carbon block during subsequent use. Because of the small size of particle 230′, the covered regions 250, 260 in Figure 2B are much smaller than the covered regions 150, 160 shown in Figure 1B. In an actual porous composite block there are many other granules and binder particles in proximity to the arrangement 200′ shown.

Figures 3A, 3B are simplified schematic cross sections that show how granules can attach to a very small binder particle with very little surface area loss when the binder melts and flows during processing according to an embodiment of the invention. Arrangement 300 shows two granules 310, 320 in contact with a very small binder particle 330 before undergoing treatment to coalesce. The granules 310, 320 and the binder particle 330 are shown as spheres for ease of illustration. In general, carbon granules have very irregular shapes.

Figure 3B shows the arrangement 300 of Figure 3A after treatment to coalesce, such as with heat and pressure. Arrangement 300′ shows that the binder particle 330 has melted and changed shape, flowing along the surfaces of granules 310, 320. Nevertheless, only small amounts of surface area 350, 360 on the granules 310, 320, respectively have been covered by melted and resolidified binder particle 330′. Even though the binder particle 330 has melted and flowed, its volume is so small that the surface areas 350, 360 covered by the resolidified binder particle 330′ are also very small. In an actual porous composite block there are many other granules and binder particles in proximity to the arrangement 300′ shown.

As has been shown in Figures 1A, 1B, 2A, 2B, 3A, 3B, particles may or may not undergo extreme shape changes after treatment to coalesce, such as with heat and pressure. In some embodiments, before treatment to coalesce, very small binder particles are approximately equiaxed, that is, they are three-dimensional with all axes of similar magnitude. The binder particles 230, 330, 430 shown in Figures 2A, 3A, 4A, respectively, are all approximately equiaxed. In some embodiments, after treatment to coalesce, very small binder particles are approximately equiaxed. The binder particle 230′ shown in Figure 2B is approximately equiaxed. In some arrangements, the binder particles 230, 230′, 330, 430 can all be described as having an average size less than about 20 μm or, on average, at least one dimension that is less than about 20 μm. In other arrangements the binder particles 230, 230′, 330, 430 can all be described as having an average particle size less than about 15 μm or, on average, at least one dimension that is less than about 15 μm. In yet other arrangements, the binder particles 230, 230′, 330, 430 can all be described as having an average size less than about 10 μm or, on average, at least one dimension that is less than about 10 μm.

In some embodiments, before treatment to coalesce, very small binder particles have morphologies that are not approximately equiaxed. In some embodiments, after treatment to coalesce, such as with heat and pressure, very small binder particles have morphologies that are not approximately equiaxed, such as binder particles 330′, 430′ shown in Figures 3B, 4B, respectively. In some arrangements, the binder particles 330′, 430′ can be described, on average, as having at least one dimension that is less than about 20 μm. In other arrangements the binder particles 330′, 430′ can be described, on average, as having at least one dimension that is less than about 15 μm. In yet other arrangements, the binder particles 330′, 430′ can be described, on average, as having at least one dimension that is less than about 10 μm.

In some embodiments, the binder particles are all made of the same material. In other embodiments, binder particles made of various materials can be used together in the same porous composite block. The binder material can be chosen independent of its melt index value.

Figures 4A, 4B are simplified schematic cross sections that show how very small binder particles 440 can attach to a group of granules 410 with very little granule surface coverage when the binder melts during processing according to an embodiment of the invention. Arrangement 400 shows several granules 410 interspersed with very small binder particles 430 before undergoing treatment to coalesce. In general, carbon granules have very irregular shapes. The granules 410 and the binder particles 430 are shown as spheres for ease of illustration. Only one sort of binder particle 430 is shown. Binder particles made of various materials may be used. In general, it would not be expected that the granules 410 would arrange themselves in such a regular fashion. In making an actual porous composite block there are many other granules and binder particles in proximity to the arrangement 400 shown. The binder particles 430 are very small and contribute a small portion to the total weight of the porous composite block.

Figure 4B shows the arrangement 400 of Figure 4A after treatment to coalesce. In arrangement 400′ the binder particles 430 have melted and flowed along the surfaces of the granules 410, shown with an idealized flowed and resolidified binder configuration 430′. Nevertheless, only small amounts of surface area on the granules 410 have been covered by the resolidified binder 430′. Even though the binder particles 430 have melted and flowed, the particle volume is so small that the granule surface areas covered by melted and resolidified binder particles 430′ are also very small.

The configuration shown in Figure 4B, can form a porous composite block that is both strong and stable without binding each granule 410 to all its nearest neighbors.

According to some embodiments of the invention, the interaction between the granules and the binder particles results in a chemical bond, that is, a bond that involves electron transfer or sharing. Examples of chemical bonds include covalent bonds, metallic bonds, and ionic bonds. In other embodiments, the interaction between the granules and the binder particles results in a physical bond, that is a bond that results from interactions among atomic or molecular dipoles. An example of a physical bond is a van der Waals bond.

If a smaller percentage of the weight of a porous composite carbon block is taken up by binder material, then a larger percentage of the weight can consist of carbon or other active granules. This is illustrated by the schematic drawings in Figures 5A and 5B. The simple porous composite carbon blocks represented in Figures 5A and 5B contain only carbon and binder.

Many polymers of interest have similar densities, that is, densities of about 0.9 – 1.0 gram/cm³. Although the density of activated carbon varies with the carbon source and processing conditions, the apparent density can be approximated at about 0.5 gram/cm³. Figure 5A illustrates the proportional volumes of components in a simple porous composite carbon block 510 that has 20 wt% binder. Binder 530 makes up 11% of the volume of the block 510, and carbon 520 makes up 88% of the volume of the block 510. Figure 5B illustrates the proportional volumes of components in a simple porous composite carbon block 540 that has 10 wt% binder. Binder 530 makes up 5% of the volume of the block 540, and carbon 520 makes up 95% of the volume of the block 540. The increase in the volume of carbon in the block 540 as compared to the block 510 is shown by region 550. The region 550 amounts to an additional 6% of carbon volume in the block 540 as compared to the block 510.

In some arrangements, as shown in the Figure 4A, small binder particles 430 contribute to the weight of the arrangement 400 but may not add much additional volume, as the particles 430 can fit in the interstices created between closely packed carbon granules 410. If the size of the binder particles is larger than can fit in the interstices between granules, the binder particles contribute to the overall volume of the arrangement. As stated earlier, the arrangement 400 in Figure 4A is idealized, but nevertheless, small binder particles may take up less volume per unit weight than large binder particles and may therefore allow room for more volume of carbon granules in the same size block.

Even if small binder particles melt during processing and wet portions of the surfaces of the carbon granules, only small portions of granule surface area are covered by the binder. Furthermore additional carbon granules can be packed into a given size block when smaller quantities of very small binder particles are used than when larger quantities of large binder particles are used. Although some carbon surface area may be lost by wetting from melted binder, additional carbon surface area can be supplied by the additional carbon granules.

The carbon blocks as described above can also include additional granular components or granular actives, such as carbon fibers, zeolites, inorganics (including activated alumina, magnesia, diatomaceous earth, silica, mixed oxides, such as hydrotalcites, glass, etc.), cationic materials (including polymers such as polyaminoamides, polyethyleneimine, polyvinylamine, polydiallyldimethylammonium chloride, polydimethylamine-epichlorohydrin, polyhexamethylenebiguanide, poly-[2-(2-ethoxy)-ethoxyethlyl-guani-dinium chloride which may be bound to fibers (including polyethylene, polypropylene, ethylene maleic anhydride copolymers, carbon, glass, etc.) and/or to irregularly shaped materials (including carbon, diatomaceous earth, sand, glass, clay, etc.), and mixtures thereof. Additional granular components can be chosen for their fluid purification properties.

According to some embodiments of the invention, binding agent materials include polymers. Polyethylene homopolymers, such as low density polyethylene (LDPE), high density polyethylene (HDPE) and ultra-high molecular weight polyethylene (UHMWPE), can be used. Modified polyethylene homopolymers, such as oxidized and carboxyl-modified polyethylene, can be used. Ethylene copolymers such as ethylene-acrylic acid, ethylene-methacrylic acid, linear low-density polyethylene (LLDPE), ethylene-vinyl acetate, ethylene-vinyl acetate-vinyl alcohol, and ethylene-methyl acrylate, can be used. Ethylene-based ion-containing copolymers can also be used.

In some other embodiments of the invention, binding agent materials include cement. Magnesium cements containing chlorides, such as Sorel cement, can be used. Magnesium cements containing sulfates, nitrates, phosphates, or fluorides can be used. Magnesium oxy phosphate can also be used. In some arrangements, proper curing of cements can be carried out by heating and removing moisture.

Exemplary polymer binder materials and some of their material properties are listed in Table I.

| | | | | Table I | | | |
|---|---|---|---|---|---|---|---|
| Binder Material | Avg. Particle Size | Melting Point (°C) | Processing Range (°C) | Minimum Binder (wt%) | Molecular weight (amu) | Density (g/cc) | Melt Index |
| Poly(ethylene-co-acrylic acid) | 10 μm | 100-105 | 140-245 | 8 | 200,000 | 0.94 | MFI 9.0g/10min 190°C/2.16kg |
| Low density polyethylene | 20 μm | 110 | 150-245 | 11 | 200,000 | 0.92 | MFI 4.70 g/10min 190°C/2.16kg |
| UHMW polyethylene | 110 μm | 138-142 | 200-245 | 13 | ~ 1M | 0.94 | HLMFI 1.8g/10min 190°C/21.6 kg |

Poly(ethylene-co-acrylic acid) is available as EA-209 from Kobo Products of South Plainfield, New Jersey. Low density polyethylene (LDPE) is available as Microthene® FN 510 from Equistar Chemicals of Houston, Texas. UHMW polyethylene is available as GUR® 2105 from Ticona of La Porte, Texas. Particles made of different binder materials can be used together in the same porous composite block.

The following examples set forth materials and methods in accordance with embodiments of the invention. It is to be understood, however, that these examples are provided by way of illustration and nothing therein should be taken as a limitation upon the overall scope of the invention.

### Example 1

A porous composite carbon block was made by mixing about 92 wt% granules (82 wt% activated carbon and 10% lead-removing agent) for removal of contaminants from water with about 8 wt% EA-209 poly(ethylene-co-acrylic acid) as a binding agent. The activated carbon had an average grain size of about 95 μm with 95% of grains between 44 μm and 177 μm (80 x 325 mesh) The lead removal agent had an average particle size of about 30 μm. The polymer had an average particle size of 9-10 μm (1250 mesh). The mixture was placed in a tubular mold with removable center rod and end pieces. The mold was heated in an oven at a temperature of about 170°C for 30 minutes. At the end of the treatment time, the mold was removed from the oven, and the block was compressed to the desired porosity as quickly as possible using a laboratory Carver press. The block was kept under compression until fully cooled. During compression the porosity of the block was measured using an air pressure drop apparatus.

| Block size | | Performance | |
|---|---|---|---|
| OD: | 1.84” | Flow Rate: | adjusted to 0.75 gpm ( 60psi) |
| ID: | 0.50” | Lead removal: | 150 ppb influent to no detect at 200 gallons |
| Length: | 2.94” | VOC removal: | 300 ppb influent / > 98% removal at 120 gallons |

### Example 2

A porous composite carbon block was made by mixing about 88 wt% granules (78 wt% activated carbon and 10% lead-removing agent) for removal of contaminants from water with about 12 wt% FN510 polyethylene as a binding agent. The activated carbon had an average grain size of about 95 μm with 95% of grains between 44 μm and 177 μm (80 x 325 mesh) The lead removal agent had an average particle size of about 30 μm. The FN510 polymer had an average particle size of about 20 μm (625 mesh). The mixture was placed in a tubular mold with removable center rod and end pieces. The mold was heated in an oven at a temperature of 190°C for 30 minutes. At the end of the treatment time, the mold was removed from the oven, and the block was compressed to the desired porosity as quickly as possible using a laboratory Carver press. The block was kept under compression until fully cooled. During compression the porosity of the block was measured using an air pressure drop apparatus.

| Block size | | Performance | |
|---|---|---|---|
| OD: | 1.84” | Flow Rate: | adjusted to 0.75 gpm ( 60psi) |
| ID: | 0.50” | Lead removal: | 150 ppb influent to no detect at 200 gallons |
| Length: | 2.94” | VOC removal: | 300 ppb influent / > 95% removal at 120 gallons |

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

1. A system for treating a fluid, comprising: a fluid source; a porous composite block that includes a first fluid treatment component in grain form and at least one binding agent in particle form, wherein, on average, at least one dimension of the particles is less than about 20 μm, and all the binding agents together constitute less than approximately 15 weight percent of the porous composite block, the porous composite block configured to receive the fluid from the fluid source; and an outlet portion associated with the porous composite block, the outlet portion providing a way for the fluid to leave the porous composite block after passing through at least a portion of the porous composite block.

2. A porous composite block comprising a first component in grain form and at least one binding agent in particle form, wherein, on average, at least one dimension of the particles is less than about 20 μm, and all the binding agents together constitute less than approximately 15 weight percent of the porous composite block.

3. The block of Claim 2 wherein, on average, at least one dimension of the particles is less than about 15 μm.

4. The block of Claim 2 wherein, on average, at least one dimension of the particles is less than about 10 μm.

5. The block of Claim 2 wherein all the binding agents together constitute less than approximately 10 weight percent of the porous composite block.

6. The block of Claim 2 wherein the average grain size is less than about 150 μm.

7. The block of Claim 2 wherein at least one binding agent is selected from the group consisting of polyethylene homopolymers, modified polyethylene homopolymers, ethylene copolymers, ethylene-based ion-containing copolymers, and magnesium cements.

8. The block of Claim 2 wherein the first granular component can interact with impurities in fluids.

9. The block of Claim 2 wherein the first granular component is selected from the group consisting of organo-clays, carbonized organic material, carbonized synthetic material, porous hydrophobic material, zeolites, and combinations thereof.

10. The block of Claim 2 wherein the first granular component is activated carbon.

11. The block of Claim 2 further comprising a second granular component selected from the group consisting of activated alumina, activated bauxite, fuller’s earth, diatomaceous earth, silica gel, calcium sulfate, ceramic particles, zeolite particles, inert particles, sand, surface charge-modified particles, metal oxides, metal hydroxides, and mixtures thereof.

12. The block of Claim 2 wherein at least a portion of at least one binding agent is attached physically to the first granular component.

13. The block of Claim 2 wherein at least a portion of at least one binding agent is attached chemically to the first granular component.

14. A porous composite carbon block for water treatment, comprising activated carbon grains intermixed with at least one binding agent in the form of particles, wherein, on average, the particles have at least one dimension less than about 20 μm, and all the binding agents together constitute less than approximately 15 weight percent of the composite block.

15. The carbon block of Claim 14 wherein, on average, the binding agent particles have at least one dimension less than about 15 μm.

16. The carbon block of Claim 14 wherein, on average, the binding agent particles have at least one dimension less than about 10 μm.

17. The carbon block of Claim 14 wherein all the binding agents together constitute less than approximately 10 weight percent of the porous composite carbon block.

18. The carbon block of Claim 14 wherein at least a portion of at least one binding agent is attached physically to the activated carbon grains.

19. The carbon block of Claim 14 wherein at least a portion of at least one binding agent is attached chemically to the activated carbon grains.

20. The carbon block of Claim 14 wherein at least one binding agent is selected from the group consisting of polyethylene homopolymers, modified polyethylene homopolymers, ethylene copolymers, ethylene-based ion-containing copolymers, and magnesium cements.

21. The carbon block of Claim 14 further comprising granular actives.

22. The carbon block of Claim 14 further comprising an inlet region, through which inlet region source water can enter the block, and an outlet region, through which outlet region treated water can leave the block.

23. The carbon block of Claim 14 wherein, for water flowing through the carbon block at a rate of at least 0.2 gallons per minute, there is a differential pressure of between about 40 psi and 80 psi between the inlet region and the outlet region.

24. The carbon block of Claim 14 wherein, for water flowing through the carbon block at a rate of at least 0.01 gallons per minute, there is a differential pressure of less than about 0.5 psi between the inlet region and the outlet region.

25. A mixture for forming a porous composite block comprising a first component in grain form and at least one binding agent in particle form, wherein average particle size is less than about 20 μm, and all the binding agents together constitute less than approximately 15 weight percent of the mixture.

26. The mixture of Claim 25 wherein the average particle size is less than about 15 μm.

27. The mixture of Claim 25 wherein the average particle size is less than about 10 μm.

28. The mixture of Claim 25 wherein all the binding agents together constitute less than approximately 10 weight percent of the mixture.

29. The mixture of Claim 25 wherein the average grain size is less than about 150 μm.

30. The mixture of Claim 25 wherein at least one binding agent is selected from the group consisting of polyethylene homopolymers, modified polyethylene homopolymers, ethylene copolymers, ethylene-based ion-containing copolymers, and magnesium cements.

31. The mixture of Claim 25 wherein the first granular component is selected from the group consisting of organo-clays, carbonized organic material, carbonized synthetic material, porous hydrophobic material, zeolites, and combinations thereof.

32. The mixture of Claim 25 further comprising a second granular component selected from the group consisting of activated alumina, activated bauxite, fuller’s earth, diatomaceous earth, silica gel, calcium sulfate, ceramic particles, zeolite particles, inert particles, sand, surface charge-modified particles, metal oxides, metal hydroxides, and mixtures thereof.

33. A mixture for forming a porous composite carbon block for water treatment, comprising activated carbon grains intermixed with at least one binding agent in the form of particles, wherein average particle size is less than about 20 μm, and all the binding agents together constitute less than approximately 15 weight percent of the mixture.

34. The carbon mixture of Claim 33 wherein the average particle size is less than about 15 μm.

35. The carbon mixture of Claim 33 wherein the average particle size is less than about 10 μm.

36. The mixture of Claim 33 wherein all the binding agents together constitute less than approximately 10 weight percent of the mixture.

37. The carbon mixture of Claim 33 wherein at least one binding agent is selected from the group consisting of polyethylene homopolymers, modified polyethylene homopolymers, ethylene copolymers, ethylene-based ion-containing copolymers, and magnesium cements.

38. The carbon mixture of Claim 33 further comprising granular actives.

39. A method of making a porous composite block, comprising, blending a first granular component with binding agent particles having an average size less than about 20 μm to form a mixture, the binding agent particles comprising less than about 15 weight percent of the mixture; forming the mixture into a shape; and coalescing the shape into a porous composite block.

40. The method of Claim 39 wherein forming the mixture into a shape comprises introducing the mixture into a mold.

41. The method of Claim 39 wherein forming the mixture into a shape comprises extruding the mixture through a die.

42. The method of Claim 39 wherein coalescing the shape comprises allowing the mixture to set.

43. The method of Claim 39 wherein coalescing the shape comprises supplying energy.

44. The method of Claim 43 wherein supplying energy comprises supplying a form of energy selected from the group consisting of electromagnetic radiation, radiative heating, inductive heating, electrically resistive heating, exothermic reactions, electric field, magnetic field, ultrasound, and light.

45. The method of Claim 39 wherein supplying energy comprises heating to a temperature between about 50°C and 300°C.

46. The method of Claim 39 wherein supplying energy comprises heating to a temperature between about 150°C and 250°C.

47. The method of Claim 39 wherein the binding agent particles have an average size less than about 20 μm.

48. The method of Claim 39 wherein the binding agent particles have an average size less than about 10 μm.
